(19) United States
(12) Patent Application Publication
(10) Pub. No.: US 2026/0016733 A1
(43) Pub. Date: Jan. 15, 2026

(54) OPTICAL SCANNER, LASER DETECTION SYSTEM, AND VEHICLE

(71) Applicant: HON HAI PRECISION INDUSTRY CO., LTD., New Taipei (TW)

(72) Inventors: HSIU-WEI KUO, New Taipei (TW); Yu-Ting Liao, New Taipei (TW)

(21) Appl. No.: 19/260,458

(22) Filed: Jul. 5, 2025

(30) Foreign Application Priority Data
Jul. 10, 2024 (CN) 202410923199.9

(51) Int. Cl. G02F 1/29; G01S 7/481; G01S 17/88

(52) U.S. Cl. CPC G02F 1/292; G01S 7/4814; G01S 7/4816; G01S 7/4817; G01S 17/88; G02F 2203/24

(57) ABSTRACT

Embodiments of the present disclosure relates to an optical scanner, a laser detection system and a vehicle. The optical scanner includes a substrate, an integrated circuit (IC), an optical phased array (OPA), a wave plate and a beam splitter. The IC is mounted on the substrate. The OPA is flip - chip soldered on a surface of the IC away from the substrate and is electrically connected with the IC. The wave plate is affixed on a side of the OPA away from the IC. The beam splitter is affixed on a side of the wave plate away from the OPA. Projections of the IC, the OPA, the wave plate and the beam splitter on the substrate all have overlapping potions.

### FIELD

The subject matter herein generally relates to lidars, specifically to an optical scanner, a laser detection system utilizing the optical scanner and a vehicle utilizing the laser detection system.

### BACKGROUND

The light detection and ranging (LiDAR) technology has a broad prospect in remote sensing and autonomous driving fields. In recent years, the flourishing development of the LiDAR market has become a driving force for the research and productization of new LiDAR technologies. One of the key points in realizing LiDAR technology is the design of the optical scanner in the laser emission device used to control the scanning of the laser beam. The optical scanner is used to convert the light source emitted by the laser to a reference light that is deflected to multiple angles of emission.

Micro-electro-mechanical system (MEMS) LiDAR is an existing LiDAR technology. The optical scanner of the laser emission device in the MEMS LiDAR has a semi-solid structure utilizing a MEMS chip, which has the disadvantage of being too large in size. The MEMS chip contains multiple mirror structures as laser radiation units, which are controlled by a lever to achieve the scanning of the laser beam. However, when the lever vibrates, it can cause the internal wires of the LiDAR to resonate, leading to a risk of fracture, thus compromising its reliability.

In addition, the optical scanner of the laser emission device in the MEMS LiDAR further includes an application-specific integrated circuit (ASIC) chip. The ASIC chip is used for electrical connection and control of the MEMS chip's operational state. Specifically, the MEMS chip and the ASIC chip are arranged on a substrate with a gap and connected by wires, resulting in excessively long wiring and response time.

Therefore, there is room for improvement in the art.

### BRIEF DESCRIPTION OF THE DRAWINGS

Implementations of the present disclosure will now be described, by way of embodiment, with reference to the attached figures.

FIG. 1 is a schematic structural diagram of an optical scanner according to an embodiment of the present disclosure.

FIG. 2 is a flow chart of a packaging method according to an embodiment of the present disclosure.

FIG. 3 is a schematic structural diagram of a laser detection system according to an embodiment of the present disclosure.

FIG. 4 is a schematic structural diagram of an OPA in FIG. 3.

FIG. 5 is a schematic structural diagram of a vehicle according to an embodiment of the present disclosure.

FIG. 6 is a schematic structural diagram of a vehicle body in FIG. 5.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term "comprising" when utilized, means "including, but not necessarily limited to"; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to "an" or "one" embodiment in this disclosure are not necessarily to the same embodiment, and such references can mean "at least one".

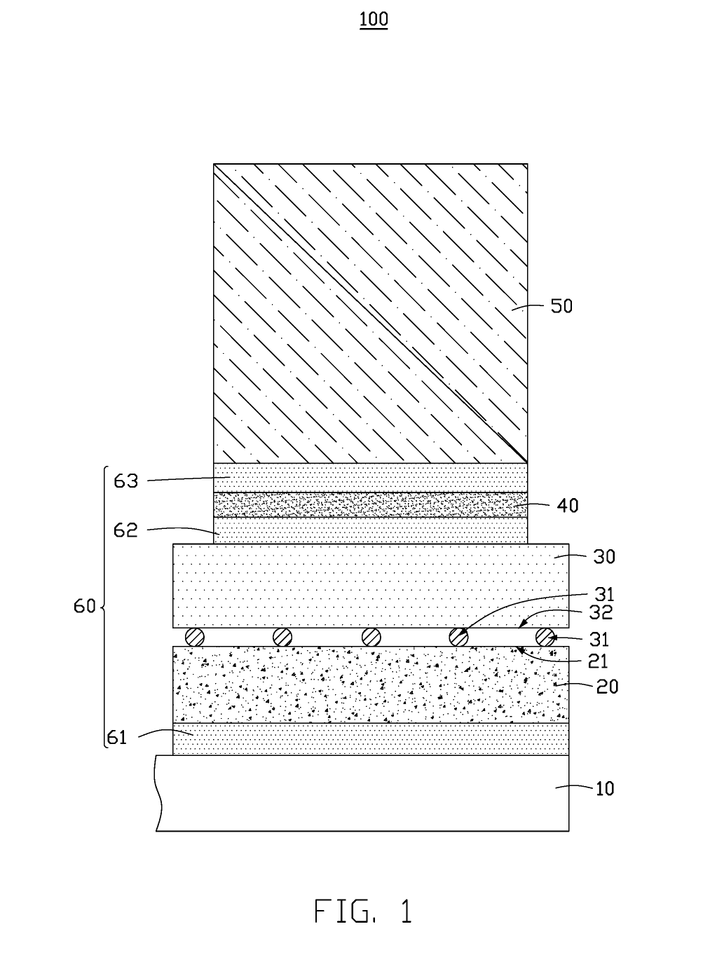

The present application embodiments provide an optical scanner applied to a laser emission device. The optical scanner is used to convert incident laser into reference light which is deflected to multiple angles. As shown in FIG. 1, the optical scanner 100 includes a substrate 10, an integrated circuit (IC) 20, an optical phased array (OPA) 30, a wave plate 40, a beam splitter 50, and an adhesive layer 60. The IC 20 is mounted on the substrate 10. The OPA 30 is flip chip soldered on a surface of the IC 20 away from the substrate 10 and is electrically connected to the IC 20. The OPA 30 further includes a plurality of bumps 31. The bumps 31 are between the IC 20 and the OPA 30 to facilitate the flip-chip bonding of the OPA 30 to the IC 20. The wave plate 40 is affixed to a side of the OPA 30 away from the IC 20. The beam splitter 50 is affixed to a side of the wave plate 40 away from the OPA 30. Projections of the IC 20, the OPA 30, the wave plate 40, and the beam splitter 50 on the substrate 10 all have overlapping potions.

In one embodiment, the adhesive layer 60 includes a plurality of films with adhesion on both sides, and each film is used for bonding adjacent two components. Specifically, the adhesive layer 60 includes a first adhesive 61, a second adhesive 62, and a third adhesive 63. The first adhesive 61 is between the substrate 10 and the IC 20 and adheres the IC 20 to the substrate 10. The second adhesive 62 is between the OPA 30 and the wave plate 40 and adheres the wave plate 40 to the OPA 30. The third adhesive 63 is between the wave plate 40 and the beam splitter 50 and adheres the beam splitter 50 and the wave plate 40.

In one embodiment, the IC 20 is an ASIC chip, which is a specialized integrated circuit customized according to different product requirements. Specifically, the IC 20 includes a first front surface 21 away from the substrate 10. The first front surface 21 is provided with a first circuit structure (not shown), and the IC 20 is electrically connected with the OPA 30 through the first circuit structure. Specifically, the IC 20 outputs an electrical signal to the OPA 30, and the electrical signal is used to control the operation state of the OPA 30.

In one embodiment, the OPA 30 is an optical phased array chip. The OPA 30 includes a second front surface 32 close to the IC 20. The second front surface 32 is opposite the first front surface 21. The second front surface 32 is provided with a second circuit structure (not shown). The second circuit structure is used for receiving and guiding the electrical signal sent by the IC 20 to the OPA 30. In other words, when the OPA 30 is mounted on the IC 20, the OPA 30 is used to flip over and directly connect to the IC 20 through the bumps 31. Specifically, the second front surface 32 further includes a plurality of connection points, and each connection point is provided with at least one bump 31 made of metal or other materials for welding. The bump 31 is located between the first front face 21 and the second front face 32 and is electrically connected with the first circuit structure and the second circuit structure respectively, so as to realize the electrical connection between the IC 20 and the OPA 30. The structural setting of the OPA 30 and the IC 20 connected through the bumps 31 has the advantages of reducing the overall volume of the optical scanner, shortening the circuit structure, and improving the transmission performance of the electrical signal.

In one embodiment, the substrate 10, the IC 20, the OPA 30, the wave plate 40, and the beam splitter 50 are sequentially stacked from bottom to top to form a vertical structure. The vertical structure design reduces the volume of the optical scanner 100 and further shortens the response time of the optical scanner 100.

In one embodiment, the second adhesive 62 and the third adhesive 63 are films made of a transparent medium and matched with the optical components to be bonded, such as optical clear resin (OCR) and optical clear adhesive (OCA), both of which have the characteristics of high light transmittance. Alternatively, the first adhesive 61 is a conductor.

The optical scanner 100 provided by the embodiments of the present disclosure the MEMS chip in the prior art is replaced by the OPA 30 to improve the reliability, and the substrate 10, the IC 20, the OPA 30, the wave plate 40, and beam splitter 50 are stacked in sequence from bottom to top , and the projections of the IC 20, the OPA 30, the wave plate 40, and the beam splitter 50 on the substrate 10 all overlap. Therefore, the optical scanner 100 is small in size and compact, the flip-chip structure of the OPA 30 on the IC 20 is beneficial to shorten the circuit structure, thus further shortening the response time of the optical scanner 100.

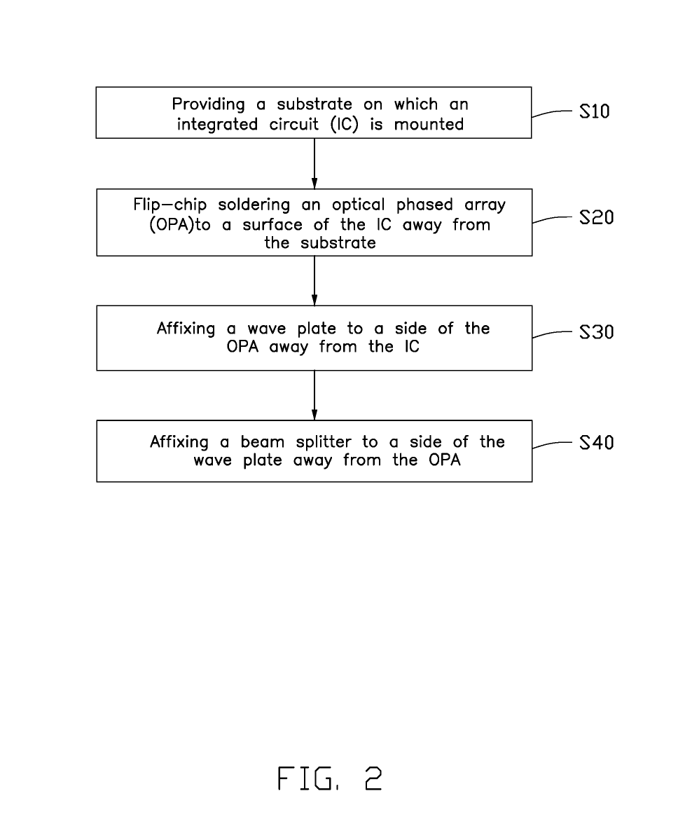

An embodiment of the present disclosure further provides a packaging method for an optical scanner. FIG. 2 shows a flowchart of the packaging method according to an embodiment of the present disclosure. The example method is provided by way of example, as there are a variety of ways to carry out the method. The method described below can be carried out using the configurations illustrated in FIG. 1, for example, and various elements of these figures are referenced in explaining the example method. Each block shown in FIG. 2 represents one or more processes, methods, or subroutines carried out in the example method. Furthermore, the illustrated order of blocks is by example only, and the order of the blocks can be changed. Additional blocks can be added, or fewer blocks can be utilized, without departing from this disclosure. The example method can begin at block S10.

In block S10, a substrate on which an IC is mounted is provided.

In block S20, a OPA is flip chip soldered to a surface of the IC away from the substrate.

In block S30, a wave plate is affixed to a side of the OPA away from the IC.

In block S40, a beam splitter is affixed to a side of the wave plate away from the OPA.

In one embodiment, taking the package of the optical scanner 100 as an example, block S20 specifically includes directly depositing bumps 31 on pads of a plurality of points of the OPA 30, so that the bumps 31 are used as the input/output (I/O) unit of the OPA 30. In another embodiment, in block S20, a re-distribution layer (RDL) is set first, and then the bumps 31 are deposited.

In one embodiment, after the bumps 31 are deposited in step S20, the OPA 30 is turned over and heated, so that the molten solder to bond with the IC 20, and the second surface 32 of the OPA 30 faces downwards, and finally the flip-chip packaging is completed.

In one embodiment, the block S10 further includes bonding the substrate and the IC with a first adhesive. The block S30 further includes bonding the OPA and the wave plate with a second adhesive, and the block S40 further includes bonding the wave plate and the beam splitter with a third adhesive.

According to the packaging method provided by the embodiment of the present disclosure, the substrate, the IC, the OPA, the wave plate, and the beam splitter are stacked sequentially from bottom to top, and the circuit structure is shortened by flip-chip packaging technology to flip-chip weld the OPA on the IC, thereby reducing the volume of the optical scanner and making the optical scanner more compact, and further shortening the response time of the manufactured optical scanner.

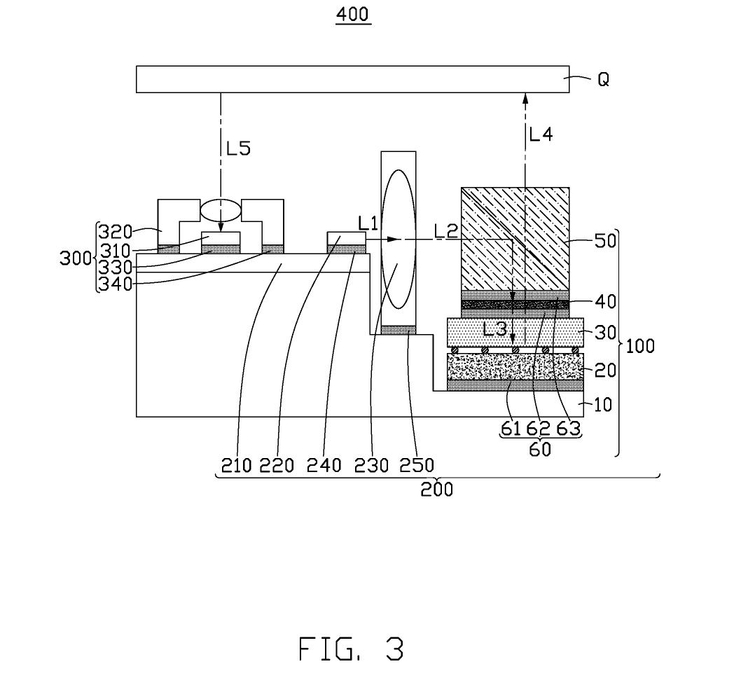

The present application embodiments further provide. FIG. 3 shows a laser detection system 400 according to an embodiment of the present disclosure. The laser detection system 400 includes a laser emission device 200 and a laser reception device 300. The laser emission device 200 includes the optical scanner 100 for emitting a reference light L4 to a target Q to be measured. The laser reception device 300 is used to receive a detection light L5 reflected by the target Q according to the reference light L4 and obtains position information of the target Q according to the detection light L5.

In one embodiment, the laser emission device 200 further includes a circuit board 210, a laser light source 220, and a collimating element 230. The circuit board 210 is mounted on the substrate 10. The laser light source 220 is mounted on a side of the circuit board 210 away from the substrate 10 for emitting a source light L1. The laser light source 220 is electrically connected to the circuit board 210. The collimating element 230 is in an optical path of the source light L1 for collimating and converting at least part of the source light L1 into a first laser L2, where the first laser L2 has a first polarization direction. The collimating element 230 is mounted on a same side of the substrate 10 as the laser light source 220. Optionally, the circuit board 210 is electrically connected to the IC 20.

In one embodiment, the laser light source 220 includes at least one light emitting array composed lasers, for example, a light-emitting array composed of lasers meeting the range performance requirements, such as edge emitting laser (EEL) or Fiber laser. Accordingly, the source light L1 at least includes the light emitted by at least one laser in the light-emitting array. For clarity in the optical path, only the optical path transformation of a single beam of light emitted by one laser is shown in FIG. 3.

In one embodiment, the first laser L2 is S-polarized light.

In one embodiment, the beam splitter 50 is in the optical path of the second laser L2 and is used to guide at least a portion of the second laser L2 through reflection. Specifically, the beam splitter 50 is a polarizing beam splitter (PBS). The PBS divides the incident light into S-polarized light and P-polarized light and reflects the S-polarized light while transmitting the P-polarized light. The second laser L2 only includes the S-polarized light reflected by the beam splitter 50. In other embodiments, the second laser L2 only includes the P-polarized light transmitted by the beam splitter 50.

In one embodiment, the wave plate 40 is in the optical path of the first laser L2 and is used to transmit the first laser L2 from the beam splitter 50 and emit the second laser L3, which has a different second polarization direction from the first polarization direction. Specifically, the wave plate 40 is a quarter-wave plate, when the first laser L2 is S polarized light, the second laser L3 emitted after passing through the wave plate 40 is circularly polarized light.

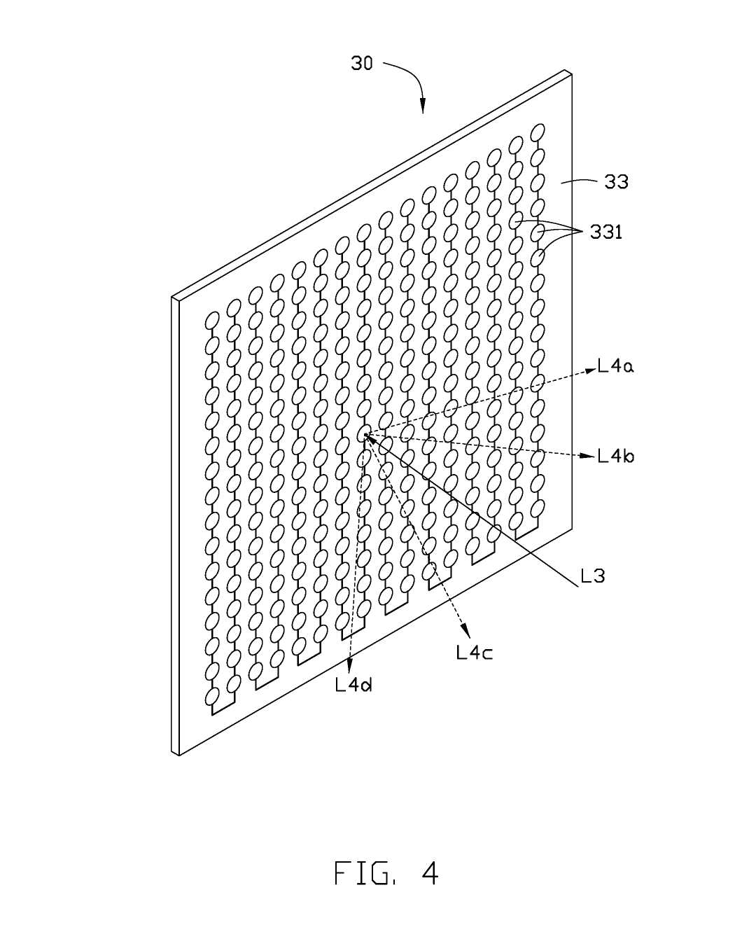

In one embodiment, the OPA 30 is in the optical path of the second laser L3 and is used to receive the second laser L3 from the wave plate 40 and emit reference light L4 to the target Q. For example, the OPA 30 can be a reflective OPA chip. Specifically, as shown in FIGS. 3 and 4, the OPA 30 further includes a reflective grating surface 33 on a side away from the IC 20 and close to the wave plate 40. The reflective grating surface 33 includes a plurality of grating units 331 arranged in an array. It should be noted that the specific structure and arrangement mode of the grating units 331 are not limited. When the second laser L3 is guided to the reflective grating surface 33, the second laser L3 undergoes refraction and reflection at the grating units 331. At this time, the control voltage output by the IC 20 to the OPA 30 is used to change the refractive index at the grating units 331, thereby changing the emission direction of light at the grating units 331. Further, the light emitted from adjacent grating units 331 interferes to form reference light L4. The reference light L4 can be emitted in multiple directions. For convenience of understanding, one beam of the incident second laser L3 is shown in FIG. 4, and four beams of reference light (L4a, L4b, L4c, L4d) emitted in four different directions are shown. The wave plate 40 and the beam splitter 50 are in the optical path of the reference light L4, and the reference light L4 is guided to the target Q after passing through the wave plate 40 and the beam splitter 50 in sequence.

In one embodiment, once the IC 20 is electrically connected to the OPA 30, the IC 20 is used to output a control signal to the OPA 30. The control signal is used to control the optical properties of the reference light L4. For example, the IC 20 changes the waveguide refractive index of the phase shifter 35 by applying voltage to the OPA 30, creating a specific phase difference between the array waveguides, which enables the modulation of the light emission of each antenna element 36a, further achieving the control of the focusing direction of the reference light L4 to realize the rotation of the reference light L4. The design of the OPA 30 is helpful to reduce the number of control electrodes, make the OPA 30 compact in size and reduce the complexity of the control circuit. The design of the OPA 30 is also helpful for reference light L4 to perform non-mechanical directional scanning flexibly, quickly and accurately, and has the advantages of high resolution, strong anti-interference and high confidentiality.

In one embodiment, the laser emission device 200 further includes a fourth adhesive 240 and a fifth adhesive 250. The fourth adhesive 240 is between the circuit board 210 and the laser light source 220 and adheres the laser light source 220 and the circuit board 210. The fifth adhesive 250 is between the substrate 10 and the collimating element 230 and adheres the collimating element 230 and the substrate 10. Specifically, the fourth adhesive 240 is a conductor, for example, a conductive adhesive specifically for chip bonding, which facilitates the electrical connection between the circuit board 210 and the laser light source 220.

In one embodiment, the laser reception device 300 further includes a photosensor 310 and a light collection element 320. The laser reception device 300 is mounted on a side of the circuit board 210 away from the substrate 10. The photosensor 310 is used for obtaining position information of the target Q according to the detection light L5, and the light collection element 320 is used to collect and guide the detection light L5 to the photosensor 310. The light collection element 320 surrounds the photosensor 310. Specifically, the laser detection system 400 can use time of flight (TOF) ranging method, amplitude modulated continuous wave (AMCW) ranging method, frequency modulated continuous wave (FMCW) ranging method, and so on to obtain the position information of the target Q by comparing the reference light L4 and the detection light L5.

In one embodiment, the laser reception device 300 further includes a sixth adhesive 330 and a seventh adhesive 340. The sixth adhesive 330 is between the photosensor 310 and the circuit board 210 and adheres the photosensor 310 and the circuit board 210. The sixth adhesive 330 is a conductor for electrically connecting the photosensor 310 and the circuit board 210. The seventh adhesive 340 is between the light collection element 320 and the circuit board 210 and adheres the light collection element 320 and the circuit board 210.

Optionally, the first adhesive 61, the second adhesive 62, the third adhesive 63, the fourth adhesive 240, the fifth adhesive 250, the sixth adhesive 330, and the seventh adhesive 340 can be selected based on the design requirements for their actual use, such as choosing materials from shadowless adhesives, thermosetting adhesives, silver adhesives, and optical matching adhesives. For example, the second adhesive 62 and the third adhesive 63 in the optical path can be chosen as the optical matching adhesive, which has a refractive index that matches the material of the optical component to be bonded.

In one embodiment, the scanning angle of the reference light L4 emitted by a single laser emission device 200 ranges from minus 15 degrees to plus 15 degrees horizontally and minus 15 degrees to plus 15 degrees vertically. A light collection angle of a single laser reception device 300 is the same as a scanning angle of a single laser emission device 200. Therefore, the laser detection system 400 can achieve the detection of distance information within an angular range of minus 15 degrees to plus 15 degrees horizontally and minus 15 degrees to plus 15 degrees vertically.

Further, the laser detection system 400 is not limited to including a group of laser emission device 200 and laser reception device 300. When the laser detection system 400 includes a plurality of groups of the laser emission devices 200 and the laser reception devices 300, it can achieve a wider scanning angle in the horizontal and/or vertical direction. For example, when the laser detection system 400 includes four groups of laser emission devices 200 and laser reception devices 300 arranged in a horizontal row, it can realize the detection of distance information within an angle range of 120 degrees in the horizontal direction and 30 degrees in the vertical direction.

The laser detection system 400 uses the laser emission device 200 with the optical scanner 100 to emit the reference light L4 and uses the laser reception device 300 to receive the detection light L5 reflected by the target Q according to the reference light L4, which fully combines the advantages of the optical scanner 100, such as compact volume, short circuit structure, and response sensitivity, and is beneficial to reduce the size of the laser detection system 400 and enhance the detection sensitivity of the laser detection system 400.

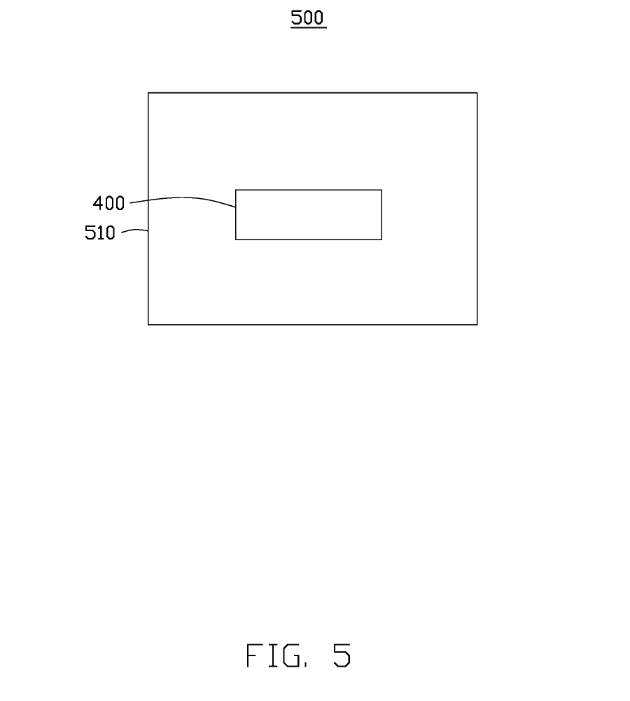

FIG. 5 shows a vehicle 500 according to an embodiment of the present disclosure. The vehicle 500 includes a vehicle body 510 and the laser detection system 400. The laser detection system 400 is mounted on the vehicle body 510, and is used to detect whether there is a target Q to be measured in a travel path of the vehicle body 510, and when there is a target Q to be measured, obtain a distance information of the target Q.

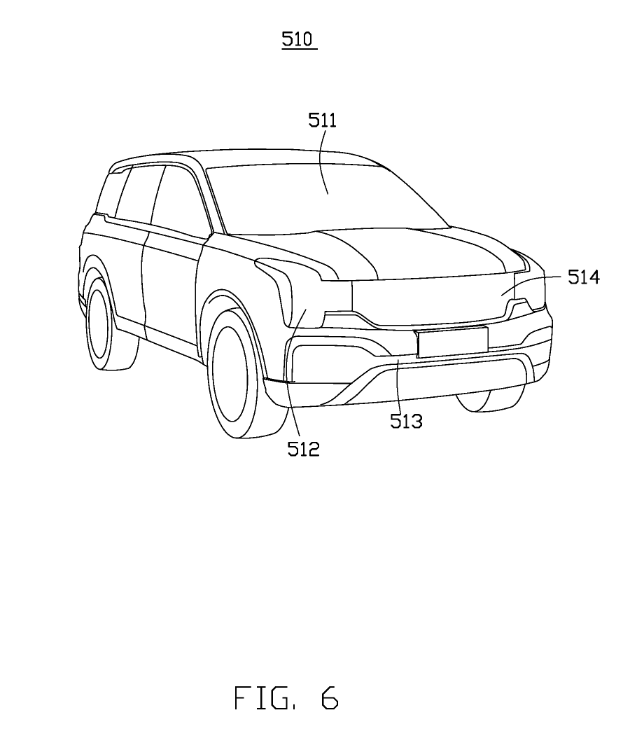

As shown in FIG. 6, the vehicle body 510 includes a windscreen 511, a headlight 512, a bumper 513, and a front grille 514. The laser detection system 400 can be installed on the windscreen 511, on the headlamp 512, on the bumper 513, and/or on the front grille 514, but is not limited to these locations.

The vehicle 500 fixes the laser detection system 400 with the optical scanner 100 on the vehicle body 510 for scanning and ranging. By fully utilizing the advantages of the laser detection system 400, such as compact size and high detection sensitivity, and helps the vehicle 500 to avoid obstacles in front of the vehicle when driving.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. An optical scanner, comprising:
a substrate;
an integrated circuit (IC) mounted on the substrate;
an optical phased array (OPA) flip -chip soldered onto a surface of the IC away from the substrate, such that the OPA is electrically connected to the IC;
a wave plate affixed to a side of the OPA away from the IC; and
a beam splitter affixed to a side of the wave plate away from the OPA;
wherein projections of the IC, the OPA, the wave plate, and the beam splitter on the substrate all have overlapping potions.

2. The optical scanner of claim 1, further comprising a first adhesive, a second adhesive, and a third adhesive, wherein the first adhesive adheres the substrate and the IC, the second adhesive adheres the OPA and the wave plate, and the third adhesive adheres the wave plate and the beam splitter.

3. The optical scanner of claim 1, wherein the IC is an application-specific integrated circuit (ASIC) chip.

4. A laser detection system, comprising:
a laser emission device comprising a laser light source for emitting a source light and an optical scanner for converting the source light into a reference light to be emitted to a target to be measured;
and a laser reception device for receiving a detection light reflected from the target according to the
reference light and obtaining position information of the target according to the detection light; wherein the optical scanner comprises: a substrate; an integrated circuit (IC) mounted on the substrate; an optical phased array (OPA) flip -chip soldered onto a surface of the IC away from the substrate, such that the OPA is electrically connected to the IC; a wave plate affixed to a side of the OPA away from the IC; and a beam splitter affixed to a side of the wave plate away from the OPA; wherein projections of the IC, the OPA, the wave plate, and the beam splitter on the substrate all have overlapping potions.

5. The laser detection system of claim 4, wherein the optical scanner further comprises a first adhesive, a second adhesive, and a third adhesive, the first adhesive adheres the substrate and the IC, the second adhesive adheres the OPA and the wave plate, and the third adhesive adheres the wave plate and the beam splitter.

6. The laser detection system of claim 4, wherein the IC is an application-specific integrated circuit (ASIC) chip.

7. The laser detection system of claim 4, wherein the laser emission device further comprises a collimating element, the collimating element is in an optical path of the source light and is configured to convert at least a portion of the source light into a first laser with a first polarization direction.

8. The laser detection system of claim 7, wherein the beam splitter is in an optical path of the first laser and is configured to guide at least a portion of the first laser to the wave plate, and the wave plate is configured to transmit the first laser from the beam splitter to emit a second laser with a second polarization direction different from the first polarization direction.

9. The laser detection system of claim 8, wherein the OPA is in an optical path of the second laser, and is configured to receive the second laser from the wave plate to emit the reference light, the reference light after passing through the wave plate and the beam splitter to the target; the IC is configured to output a control signal to the OPA, the control signal being configured to control a focusing direction of the reference light.

10. The laser detection system of claim 4, wherein the laser reception device comprises a photosensor and a light collection element, the photosensor is configured to obtain a position information of the target to be measured based on the detection light, and the light collection element is configured to collect and direct the detection light to the photosensor.

11. A vehicle, comprising:
a vehicle body; and
a laser detection system mounted on the vehicle body and configured to detect whether there is a target to be measured in a travel path of the vehicle body, and when there is the target, obtain a distance information of the target; the laser detection system comprising a laser emission device and a laser reception device, the laser emission device comprising a laser light source for emitting a source light and an optical scanner for converting the source light into a reference light to be emitted to the target, the laser reception device being configured to receive a detection light reflected from the target according to the reference light and obtain position information of the target according to the detection light;
wherein the optical scanner comprises: a substrate; an integrated circuit (IC) mounted on the substrate; an optical phased array (OPA) flip -chip soldered onto a surface of the IC away from the substrate, such that the OPA is electrically connected to the IC; a wave plate affixed to a side of the OPA away from the IC; and a beam splitter affixed to a side of the wave plate away from the OPA;
wherein projections of the IC, the OPA, the wave plate, and the beam splitter on the substrate all have overlapping potions.

12. The vehicle of claim 11, wherein the optical scanner further comprises a first adhesive, a second adhesive, and a third adhesive, the first adhesive adheres the substrate and the IC, the second adhesive adheres the OPA and the wave plate, and the third adhesive adheres the wave plate and the beam splitter.

13. The vehicle of claim 11, wherein the IC is an application-specific integrated circuit (ASIC) chip.

14. The vehicle of claim 11, wherein the laser emission device further comprises a collimating element, the collimating element is in an optical path of the source light and is configured to convert at least a portion of the source light into a first laser with a first polarization direction.

15. The vehicle of claim 14, wherein the beam splitter is in an optical path of the first laser and is configured to guide at least a portion of the first laser to the wave plate, and the wave plate is configured to transmit the first laser from the beam splitter to emit a second laser with a second
polarization direction different from the first polarization direction.

16. The vehicle of claim 15, wherein the OPA is in an optical path of the second laser, and is configured to receive the second laser from the wave plate to emit the reference light, the reference light after passing through the wave plate and the beam splitter to the target; the IC is configured to output a control signal to the OPA, the control signal being configured to control a focusing direction of the reference light.

17. The vehicle of claim 11, wherein the laser reception device comprises a photosensor and a light collection element, the photosensor is configured to obtain a position information of the target to be measured based on the detection light, and the light collection element is configured to collect and direct the detection light to the photosensor.
